(19) United States
(12) Patent Application Publication
(10) Pub. No.: US 2024/0380015 A1
(43) Pub. Date: Nov. 14, 2024

(54) THERMAL RUNAWAY DETECTION CIRCUIT

(71) Applicant: VOLVO TRUCK CORPORATION, Göteborg (SE)

(72) Inventor: Emil LIDSTRÖM, Torslanda (SE)

(73) Assignee: VOLVO TRUCK CORPORATION, Göteborg (SE)

(21) Appl. No.: 18/658,106

(22) Filed: May 8, 2024

(30) Foreign Application Priority Data
May 9, 2023 (EP) 23172466.7

(51) Int. Cl. H01M 10/48; H01M 10/42

(52) U.S. Cl. CPC H01M 10/486; H01M 10/4257; H01M 10/482; H01M 2220/20

(57) ABSTRACT

A thermal runaway detection circuit is presented. The thermal runaway detection circuit comprises a processing circuit, a first electric conduit configured to connect the processing circuit to a first sensor circuit and a second electric conduit configured to connect the processing circuit to a second sensor circuit. A portion of the first electric conduit and a portion of the second electric conduit between the processing circuit and the respective sensor circuit are configured to be arranged at an over pressure relief path of a battery device. The processing circuit is configured to obtain first data via the first electric conduit and second data via the second electric conduit, and generate a thermal runaway indication based on the first data and the second data.

### TECHNICAL FIELD

The disclosure relates generally to safety arrangements for power sources. In particular aspects, the disclosure relates to circuitry for detection of thermal runaway in a battery. The disclosure can be applied to battery systems of heavy-duty vehicles, such as trucks, buses, and construction equipment, among other vehicle types. Although the disclosure may be described with respect to a battery system of a particular vehicle, the disclosure is not restricted to battery systems for vehicles.

### BACKGROUND

A number of electrical vehicles powered by batteries is constantly increasing. This has pushed the development of battery technology and energy density of batteries has increased significantly in the past years. With the increase energy density, there is an increased risk of the battery experiencing thermal runaway.

Thermal runaway in batteries is a phenomenon in which a temperature of a battery increases rapidly and uncontrollably. This leads to a cascade of reactions that may result in a fire or an explosion. Thermal runaway may occur in any type of battery, but is more common in lithium-ion batteries due to their high energy density.

The thermal runaway process may be initiated by an external factor such as overcharging, short-circuiting, physical damage to the battery, or exposure to high temperatures. Once initiated, the thermal runaway can quickly become self-sustaining as the heat generated by the chemical reactions within the battery further increases the temperature, leading to a rapid increase in the rate of these reactions.

The consequences of thermal runaway may be severe. Thermal runaway may lead to release of toxic gases, fire, and/or explosion, depending on the type and size of the battery. To prevent thermal runaway, battery manufacturers employ various safety measures, including using materials that are less prone to thermal runaway, incorporating thermal management systems, and implementing battery management systems that monitor and control the battery's charging and discharging cycles. These systems may be expensive and prone to give false positives which causes unnecessary downtime for e.g. a vehicle powered by such a battery.

There is a need for a system, device or method that will provide a reliable indication that thermal runaway is imminent which may be utilized to generate e.g. warnings or alerts.

From the above, it is understood that there is a need for improvements and/or alternatives.

### SUMMARY

According to a first aspect of the disclosure, a thermal runaway detection circuit is presented. The thermal runaway detection circuit comprises a processing circuit, a first electric conduit configured to connect the processing circuit to a first sensor circuit and a second electric conduit configured to connect the processing circuit to a second sensor circuit. A portion of the first electric conduit and a portion of the second electric conduit between the processing circuit and the respective sensor circuit are configured to be arranged at an over pressure relief path of a battery device. The processing circuit is configured to obtain first data via the first electric conduit and second data via the second electric conduit, and generate a thermal runaway indication based on the first data and the second data. A technical benefit may include decreasing a risk of generating false thermal runaway indications.

In some examples, including in at least one preferred example, optionally, the processing circuit is configured to generate the thermal runaway indication responsive to the first data being outside a first interval and the second data being outside a second interval. This is beneficial as it decreases a risk of generating false thermal runaway indications.

In some examples, including in at least one preferred example, optionally, the thermal runaway detection circuit further comprises a first impedance control circuit connected to the first electric conduit between the processing circuit and the over pressure relief path and/or a second impedance control circuit connected to the second electric conduit between the processing circuit and the over pressure relief path. This is beneficial as it ensures a controlled impedance at the electrical conduit connected to the impedance control circuit.

In some examples, including in at least one preferred example, optionally, the first impedance control circuit is connected to the first electric conduit between the processing circuit and the portion of the first electric conduit configured to be arranged at the over pressure relief path and/or the second impedance control circuit is connected to the second electric conduit between the processing unit and the portion of the second electric conduit configured to be arranged at the over pressure relief path.

In some examples, including in at least one preferred example, optionally, the processing circuit is configured to generate the thermal runaway indication responsive to the first data indicating a first data maximum value or a first data minimum value and/or the second data indicating a second data maximum value or a second data minimum value. This is beneficial as it decreases a risk of generating false thermal runaway indications.

In some examples, including in at least one preferred example, optionally, at least a portion of the first electric conduit and a portion of the second electric conduit are arranged on a printed circuit board, PCB. This simplifies production and assembly of the thermal runaway detection circuit.

In some examples, including in at least one preferred example, optionally, the PCB is a flexible printed circuit, FPC. This simplifies production and assembly of the thermal runaway detection circuit.

In some examples, including in at least one preferred example, optionally, the thermal runaway detection circuit further comprises a first impedance control circuit connected to the first electric conduit between the processing circuit and the over pressure relief path and a second impedance control circuit connected to the second electric conduit between the processing circuit and the over pressure relief path. The processing circuit is configured to generate the thermal runaway indication responsive to the first data indicating a first data maximum value or a first data minimum value and the second data indicating a first data maximum value or a first data minimum value. The processing circuit is further configured to generate the thermal runaway indication responsive to the first data being outside a first interval and the second data being outside a second interval. At least a portion of the first electric conduit and a portion of the second electric conduit are arranged on a printed circuit board, (PCB). The PCB is a flexible printed circuit (FPC).

According to a second aspect of the disclosure, a battery device is presented. The battery device comprises at least one battery cell, a first sensor circuit, a second sensor circuit, a housing enclosing the at least one battery cell and comprising an over pressure relief path, and a thermal runaway detection circuit of the first aspect connected to the first sensor circuit and the second sensor circuit. The first electric conduit and the second electric conduit of the thermal runaway detection circuit are arranged at the over pressure relief path.

In some examples, including in at least one preferred example, optionally, the battery device further comprises a pressure relief valve arranged to control the over pressure relief path.

In some examples, including in at least one preferred example, optionally, the first sensor circuit and/or the second sensor circuit are one of a temperature sensor, a voltage sensor or a current sensor.

In some examples, including in at least one preferred example, optionally, at least a portion of the first electric conduit and a portion of the second electric conduit of the thermal runaway detection circuit may be arranged on a printed circuit board, PCB, of the battery device.

According to a third aspect of the disclosure, a vehicle comprising at least one battery device of the second aspect is presented.

In some examples, including in at least one preferred example, optionally, the vehicle is configured to alert an operator of the vehicle responsive to the battery device generating a thermal runaway indication.

According to a fourth aspect of the disclosure, a method of detecting thermal runaway of a battery device of the second aspect is presented. The method comprises obtaining first data from the first electric conduit and second data from the second electric conduit, and generating a thermal runaway indication based on the first data and the second data.

In some examples, including in at least one preferred example, optionally, generating a thermal runaway indication comprises generating the thermal runaway indication responsive to the first data being outside a first interval, and the second data being outside a second interval.

In some examples, including in at least one preferred example, optionally, generating a thermal runaway indication comprises generating the thermal runaway indication responsive to the first data indicating a first data maximum value or a first data minimum value, and the second data indicating a second data maximum value or a second data minimum value.

The disclosed aspects, examples (including any preferred examples), and/or accompanying claims may be suitably combined with each other as would be apparent to anyone of ordinary skill in the art. Additional features and advantages are disclosed in the following description, claims, and drawings, and in part will be readily apparent therefrom to those skilled in the art or recognized by practicing the disclosure as described herein.

There are also disclosed herein computer systems, control units, code modules, computer-implemented methods, computer readable media, and computer program products associated with the above discussed technical benefits.

### BRIEF DESCRIPTION OF THE DRAWINGS

Examples are described in more detail below with reference to the appended drawings.

FIG. 1 is an exemplary vehicle according to an example.

FIG. 2 is an exemplary thermal runaway detection circuit according to an example.

FIG. 3 is an exemplary battery device according to an example.

FIG. 4 are exemplary time series plots of data according to an example.

FIG. 5a is an exemplary impedance control circuit according to an example.

FIG. 5b is an exemplary impedance control circuit according to an example.

FIG. 6 is an exemplary battery device according to an example.

FIG. 7 is an exemplary battery pack according to an example.

FIG. 8 is an exemplary method for detecting thermal runaway according to an example.

FIG. 9 is a schematic diagram of an exemplary computer system for implementing examples disclosed herein, according to an example.

### DETAILED DESCRIPTION

The detailed description set forth below provides information and examples of the disclosed technology with sufficient detail to enable those skilled in the art to practice the disclosure.

As previously indicated, thermal runaway of a battery cell may cause release of toxic gases, fire, and/or explosion. In order to reduce a risk of e.g. injury, or even death, of persons in a vicinity of a battery cell undergoing thermal runaway, a reliable warning system is desired. Such warning systems are especially important for vehicles as these are generally operated by a driver that should evacuate the vehicle immediately in case of thermal runaway of one or more battery cells of the vehicle. In addition to this, some vehicles offer live in possibilities for a driver which means that a driver may sleep or rest in a vehicle. This is common for heavy duty vehicles such as trucks.

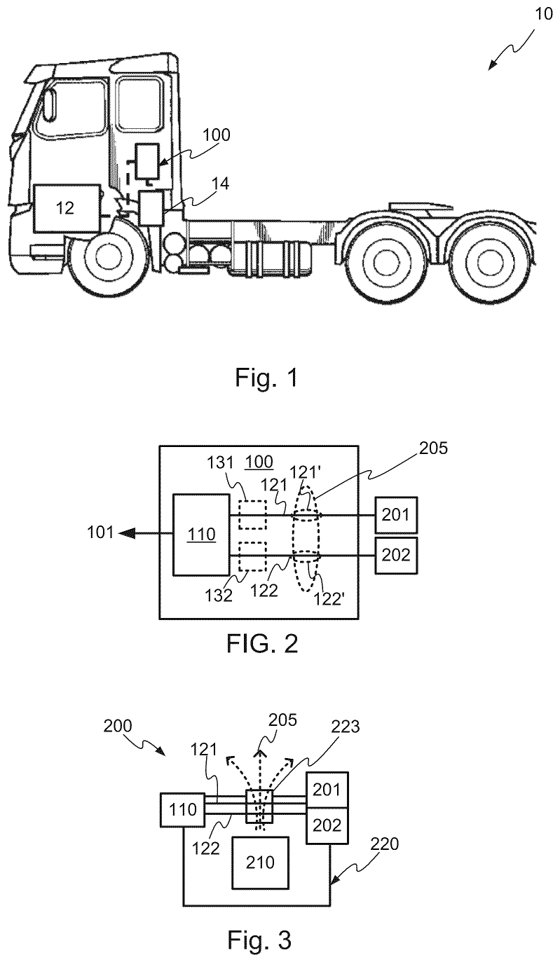

FIG. 1 is an exemplary view of a vehicle 10 according to an example is shown. The vehicle is shown as a truck, but the teachings of the present disclosure are applicable not only to any type of vehicle 10, but to any type of battery system, not only battery systems for vehicles 10.

The vehicle 10 of FIG. 1 is an, at least partly, electrically propelled vehicle 10. To this end, the vehicle 10 comprises one or more motors 12 arranged to propel the vehicle and one or more electrical power sources 14 configured to provide power to the one or motors 12 and/or other functionality of the vehicle 10. The vehicle further comprises a thermal runaway detection circuit 100 arranged to detect thermal runaway in one or more battery cells of the vehicle 10.

Although the vehicle 10 of FIG. 1 is described as an, at least partly, electrically propelled vehicle 10, the vehicle may, in some examples, be a vehicle 10 propelled solely by a combustion engine. In such examples, electrical power sources 14 may be provided to power electronics controlling the combustion engine (fuel injection etc.) or comfort systems of the vehicle (thermal control of a cabin of the vehicle, auxiliary equipment such as refrigerators, GPS etc.). In short, the thermal runaway detection circuit 100 may be utilized with any suitable electrical power source 14 at a risk of experiencing thermal runaway or similar effects.

FIG. 2 is an exemplary block diagram of a thermal runaway detection circuit 100 according to some examples of the present disclosure. The thermal runaway detection circuit 100 comprises at least two electrical conduits 121, 122 and at least one processing circuit 110. The electrical conduits 121, 122 may be any suitable conduit conducting electricity such as a conducting wire, a trace on a circuit board etc. The electrical conduits 121, 122 are electrically connected to the processing circuit 110 and configured to provide an electrical connection between the processing circuit 110 and respective peripheral circuits 201, 202. The peripheral circuits 201, 202 may be any suitable circuit such as, but not limited to, further processing circuits, memory circuits, amplifier circuits, control circuits etc. In an advantageous example, the peripheral circuits 201, 202 are sensor circuits such as, but not limited to, voltage sensor circuits, current sensor circuits, temperature sensor circuits etc.

In FIG. 2, a first electrical conduit 121 is configured to connect the processing circuit 110 to a first peripheral circuit 201 in the form of a first sensor circuit 201. In FIG. 2, a second electrical conduit 122 is configured to connect the processing circuit 110 to a second peripheral circuit 202 in the form of a second sensor circuit 202. The first sensor circuit 201 is advantageously different from the second sensor circuit 202.

In some examples, the first sensor circuit 201 is a voltage sensor circuit and the second sensor circuit 202 is a temperature sensor circuit.

The processing circuit 110 may be any suitable processing circuit 110. Generally, battery devices are provided with processing circuits of some sort configured to monitor e.g. a temperature and a voltage of an associated battery or battery cell(s). The processing circuit 110 of the thermal runaway detection circuit 100 may very well be such a processing circuit. In some examples, the processing circuit 110 of the thermal runaway detection circuit 100 is a processing circuit 110 electrically connected to a processing circuit connected to the sensor circuit 201, 202 by the electrical conduits 121, 122. With that said, the sensor circuits 201, 202 are connected to the processing circuit 110 of the thermal runaway detection circuit 100 via the electrical conduits 121, 122, but the connection may be via further (processing) circuits.

The processing circuit 110 is configured to generate thermal runaway indication 101 responsive to determining that a thermal runaway occurring. This will be further detailed in the following. It should be mentioned already now that there may be a plurality of processing circuits 110 involved in generating the thermal runaway indication 101. Not all processing circuits 110 need to be mounted at the battery cells and/or may be comparably simple processing circuits 110 (or analog front end, (AFE)) that may be arranged e.g. at a vicinity of the battery cells and configured to e.g. obtain the data from one or more sensor circuits 201, 202 and provide that data to processing circuit 110 located distal from the battery cells.

The inventor behind the present disclosure have realized that, by arranging the electrical conduits 121, 122 such that they are damaged in case of thermal runaway of a battery device 200 (see FIG. 3), thermal runaway may be accurately and reliably detected. To this end, the first electrical conduit 121 and the second electrical conduit 122 are configured to be arranged at an over pressure relief path 205 of a battery device 200. As the skilled person appreciates, when it is specified that the first electrical conduit 121 and the second electrical conduit 122 are configured to be arranged at the over pressure relief path 205, this is generally to be interpreted as a portion 121′ of the first electrical conduit 121 and a portion 122′ of the second electrical conduit 122 being configured to be arranged at the over pressure relief path 205. The term “at the over pressure relief path 205” may be interpreted as in the vicinity of the over pressure relief path 205, across the over pressure relief path 205, adjacent to the over pressure relief path 205 and may be interpreted differently for each of the first electrical conduit 121 and the second electrical conduit 122. Functionally, the first electrical conduit 121 and the second electrical conduit 122 are configured to be arranged at the over pressure relief path 205 such that the first electrical conduit 121 and the second electrical conduit 122 are damaged (e.g. broken) responsive to triggering of a pressure relief valve 223 (see FIG. 3) associated with the over pressure relief path 205.

This is illustrated in FIG. 3 wherein an exemplary view of a battery device 200 is shown. The battery device 200 comprises one or battery cells 210. In FIG. 3, only one battery cell 210 is shown, but the battery device 200 may comprise any number of battery cells 210. The battery device 200 further comprises a housing 220 enclosing the battery cell(s) 210. In FIG. 3, the peripheral circuits 201, 202 are shown as external to the housing 220. In some examples, the peripheral circuits 201, 202 are internal to the housing 220. In some examples, the battery device 200 comprises the peripheral circuits 201, 202. In some examples, the thermal runaway detection circuit 100 is separate from the battery device 200. In some examples, the battery device 200 comprises the thermal runaway detection circuit 100.

In FIG. 3, the housing 220 is provided with a pressure relief valve 223. This is one example, and pressure relief valves 223 may, additionally, or alternatively, be provided in e.g. casings of the battery cells 210. The pressure relief valve 223 is provided in order to prevent the battery device 200 from being disfigured, exploding or rupturing due to excessive pressure build-up within the housing 220. Such pressure build-up may result from the battery cell 210 battery being charged. Venting of gas during charging may be comparably harmless as a comparably small volume of gas is released. If a thermal runaway occurs, gases released will have a comparably higher temperature and a volume of gases released will be comparably greater.

The vented gases will escape the housing 220 through the pressure relief valve 223 along an over pressure relief path 205 of the battery device 205. The over pressure relief path 205 is a fluid path of vented gases (heated fumes) and is a path originating inside the housing 220, passing through the pressure relief valve 223 and ending outside the housing 220.

In FIG. 3, the first electric conduit 121 and the second electric conduit 122 are arranged at the over pressure relief path 205. The first electric conduit 121 and the second electric conduit 122 are arranged such that the over pressure relief path 205 is provided between the processing circuit 110 and the first and second sensor circuit 201, 202. This means that, responsive to heated fumes being released through the pressure relief valve 223 (along the pressure relief path 205), the first and second electric conduits 121, 122 will be subjected to the heated fumes and break. As the first and second electric conduits 121, 122 are broken by the vented gases, the electrical connection between the processing circuit 110 and the sensor circuits 201, 202 is broken. The first and second sensor circuit 201, 202 may be arranged remote from the over pressure relief path 205. Thereby, the sensor circuit 201, 202 may remain intact in the event of a thermal runaway. In an example, the first and second electric conduit 201, 202 may extend across a plurality of over pressure relief paths 205. Thereby, the electric conduits 201, 202 may be utilized for monitoring of a plurality of battery devices 200.

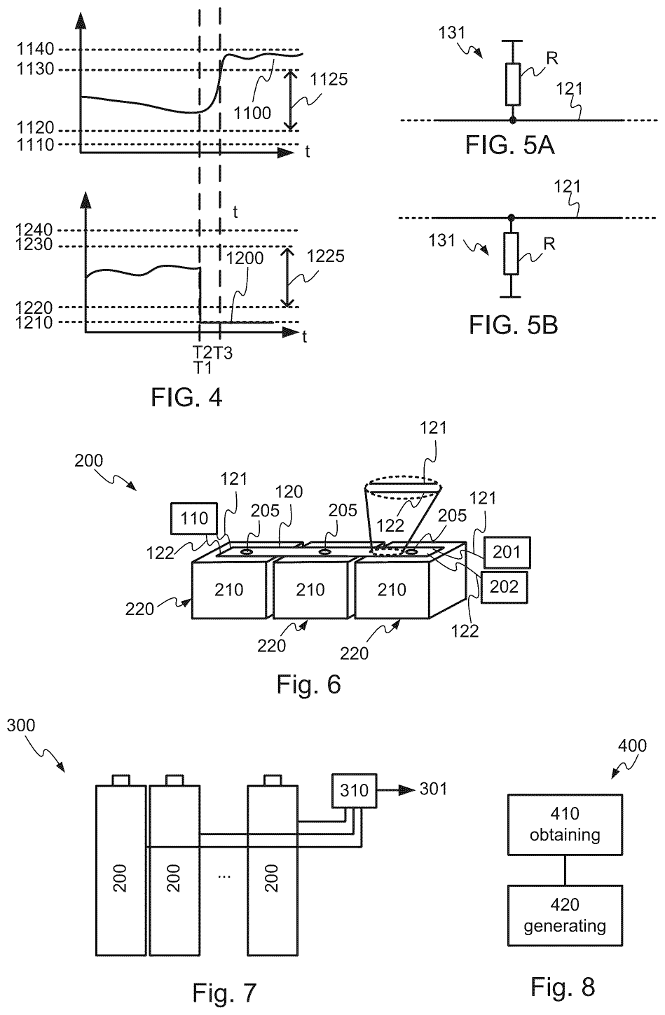

By arranging the first electrical conduit 121 and the second electrical conduit 122 as exemplified above, a thermal runaway may be reliably distinguished from other failures and a risk of false alarms, i.e. false positive detections, is greatly reduced. To exemplify, a voltage sensor may occasionally fail causing incorrect readings that may correspond to a damaged or broken electrical conduit 201, 202. It may be that external disturbances caused by e.g. electromagnetic interference (EMI) will bias, saturate or disturb an analog to digital converter configured to sense a temperature of the battery cell 210 by a sensor circuit 201, 202 in the form of a thermistor resulting in readings that may correspond to a damaged or broken electrical conduit 121, 122. However, a probability of both sensor circuits 201, 202 malfunctioning at a same point in time is highly unlikely, and by configuring the processing circuit 110 to monitor two independent sensor circuits 201, 202 via two independent electric conduits 121, 122, thermal runaway may be reliably detected. To this end, the processing circuit 110 is advantageously configured to monitor data 1100, 1200 (scc FIG. 4) at the electrical conduits 121, 122. Accordingly, the first sensor circuit 201 and the second sensor circuit 202 may be independent from each other. Correspondingly, the first electric conduit 121 and second electric conduit 122 may be independent from each other. The first sensor circuit 201 and the first electric conduit 121 as well as the second sensor circuit 202 and the second electric conduit 122 may form circuits separate from each other.

In FIG. 4, two exemplary graphs of data 1100, 1200 versus time is shown. In the top graph in FIG. 4, a time series plot of first data 1100 is shown, in the bottom graph in FIG. 4, a time series plot of second data 1200 is shown. The data 1100, 1200 shown in FIG. 4 is exemplary and provided as basis for explanation only. The data 1100, 1200 may be analogue or digital data. The first data 1100 is data obtained from the first electric conduit 121 and the second data 1200 is data obtained from the second electric conduit 122. With that said, assuming that the first and second conduits are undamaged, the first data 1100 is data obtained from the first sensor circuit 201 and the second data 1200 is data obtained from the second sensor circuit 202. Generally, the first data 1100 is associated with a first minimum data value 1110 indicating a lowest possible data value indicatable by the first data 1100 and a first data maximum data value 1140 indicating a highest possible data value indicatable by the first data 1100. Correspondingly, the second data 1200 is associated with a second minimum data value 1210 indicating a lowest possible data value indicatable by the second data 1200 and a second data maximum data value 1240 indicating a highest possible data value indicatable by the second data 1200. As the skilled person will understand, the minimum and maximum data values 1110, 1210, 1140, 1240 indicatable by the first or second data 1100, 1200 may be different or the same for the same for the first and second data 1100, 1200. Further the minimum and maximum data values 1110, 1210, 1140, 1240 indicatable by the first or second data 1100, 1200 may be determined by e.g. number of bits in a digital representation of the first or second data 1100, 1200, control voltages of the processing circuit 110 or sensor circuits 201, 202 etc. The first data 1100 may be compared to a first interval 1125 defined as an interval between a first interval first level 1120 and a first interval second level 1130. Correspondingly, the second data may be compared to a second interval 1225 defined as an interval between a second interval first level 1220 and a second interval second level 1230. The first data may be independent from the second data.

Based on the data 1100, 1200 it may be determined it the associated electrical conduit 121, 122 is damaged or not. In FIG. 4, a thermal runaway occurs at a first point in time T1 indicated by the leftmost vertical dashed line. As the thermal runaway occurs, the pressure relief valve 223 of the associated battery device 200 is opened, releasing heated gases that cause the first electrical conduit 121 and the second electrical conduit 122 to break. As a result, in FIG. 4, the second data 1200 assumes the second data minimum value 1210 at a second point in time T2 occurring substantially at the same time as the first point in time T1. At a third point in time T3, indicated by the leftmost vertical line in FIG. 4, the first data 1100 assumes a value outside the first interval 1125. Assuming that the first interval 1125 and second interval 1225 indicate allowable, expected or normal data values for the first and second data 1100, 1200 respectively, both the first data 1100 and the second data 1200 exhibit erroneous, false or unexpected values after the third point in time T3. Responsive thereto, the processing circuit 110 is advantageously configured to generate the thermal runaway indication 101 (FIG. 2).

In FIG. 4, it may be assumed that the first electrical conduit 121 is connected to a first sensor circuit 201 in the form of a voltage sensor. An input at the processing circuit may be a high impedance input which means that the first electrical conduit 121 is left at a high impedance state at the processing circuit 110 after being broken by the thermal runaway at the first point in time T1. The high impedance state causes the electrical conduit 121 to be charged by e.g. stray electromagnetic fields. This causes the first data 1100 obtained by the processing circuit 110 to indicate an increase in voltage. However, the second data 1200 assumes the second data minimum value 1210 at the second point in time T2. This may be due to the second electrical conduit 122 having a pull-down circuitry arranged between the over pressure relief path 205 and the processing circuit 110.

From FIG. 4, it may be concluded that indication of a broken electrical conduit 121, 122 is provided faster at the second electrical conduit 122 than the first electrical conduit 121 due to the controlled impedance of the second electrical conduit 122. To this end, see FIG. 2, a first impedance control circuit 131 may be connected to the first electric conduit 121 between the processing circuit 110 and the over pressure relief path 205. Alternatively, or additionally, a second impedance control circuit 132 may be connected to the second electric conduit 122 between the processing circuit 110 and the over pressure relief path 205.

In FIG. 5a, the first impedance control circuit 131 is shown as a pull-up resistor R arranged on the first electrical conduit 121. In FIG. 5b, the first impedance control circuit 131 is shown as a pull-down resistor R arranged on the second electric conduit 121. The skilled person will understand the second impedance control circuit 132 may be exemplified correspondingly to the first impedance control circuit 131. In some examples, the first impedance control circuit 131 and/or the second impedance control circuit 132 is comprised in the processing circuit 110. In some examples, the processing circuit 110 is an MCU wherein ports connected to the first electric conduit 121 and the second electrical conduit 122 may be configured with an, to the processing circuit 110, internal pull-up or pull-down impedance.

In FIG. 6, a battery device comprising more than one battery cell 210 is shown. In FIG. 6, a portion of the first electrical conduit 121 and a portion of the second electrical conduit 122 are provided on a printed circuit board (PCB) 120, see magnified portion of PCB 120 in FIG. 6. In FIG. 6, the PCB 120 is arranged across the over pressure relief paths 205 of each of the battery cells 210. In some examples, the PCB 120, and thereby a portion of the first electrical conduit 121 and a portion of the second electrical conduit 122, may be arranged on the housing 220 of a battery device 200 such as the battery device 200 shown in FIG. 3. Arranging a portion of the first electrical conduit 121 and a portion of the second electrical conduit 122 on the PCB is beneficial at it simplified assembly and arrangement of the electric conduits 121, 122 at the over pressure relief path 205 of an associated battery device 200. Further, arranging a portion of the first electrical conduit 121 and a portion of the second electrical conduit 122 on the PCB 120 improves stability of the battery device 200 and reduces a risk at the electric conduits 121, 122 are damaged by e.g. vibrations etc.

In some further examples, the PCB 120 may a flexible printed circuit (FPC) further simplifying assembly and arrangement of the electrical conduits. The FPC further reduces a risk that the electric conduits 121, 122 are damaged by e.g. vibrations.

In FIG. 7, a battery pack 300 according to one example is shown. The battery pack 300 comprises two or more battery devices 200 as presented herein. The battery pack 300 of FIG. 7 is shown as comprising three battery devices 200, but the battery pack 300 may comprise any suitable number of battery devices 200. The battery pack 300 further comprises a battery pack processing circuit 310. The battery pack processing circuit 310 is advantageously connected to each of the processing circuits 110 of the thermal runaway detection circuits 100) of the battery devices 200 of the battery pack 300.

Advantageously, the battery pack processing circuit 310 is configured to obtain thermal runaway indications 101 from the processing circuits 110 of the thermal runaway detection circuits 100 of the battery devices 200 of the battery pack 300. The battery pack processing circuit 310 may be configured to generate a battery pack thermal runaway indication 301. The battery pack thermal runaway indication is advantageously generated responsive to obtaining the battery pack processing circuit 310 obtaining a thermal runaway indication 101 from at least one of the processing circuits 110 of the two or more battery devices 200 of the battery pack 300.

In some examples, in order to further decrease a risk of false thermal runaway alarms, the battery pack processing circuit 310 may be configured to generate the battery pack thermal runaway indication 301 after obtaining thermal runaway indications 101 from at least two of the processing circuits 110 of the battery devices 200 of the battery pack 300.

From the description of the thermal runaway detection circuit 100 and the associated battery devices 200 and battery packs 300 given herein, it is clear that a more reliable device for detecting thermal runaway is provided. Advantageously, in examples wherein the thermal runaway detection circuit 100, the associated battery devices 200 or battery packs 300 are provided in a vehicle 10, see FIG. 1, the vehicle 10 is advantageously configured to alert an operator of the vehicle 10 responsive to the thermal runaway detection circuit 100, the associated battery devices 200 or battery packs 300 generating a thermal runaway indication 101, 301.

In FIG. 8 a method 400 of detecting thermal runaway is shown. The method 400 is suitable for detecting thermal runaway in a battery device 200 as presented herein. The method comprises obtaining 410 first data 1100 from the first electric conduit 121 and second data 1200 from the second electric conduit 122. The method 400 further comprises generating 420 the thermal runaway indication 101 based on the first data 1100 and the second data 1200 as taught herein.

In some examples, the processing circuit 110 is configured to perform the method of FIG. 8.

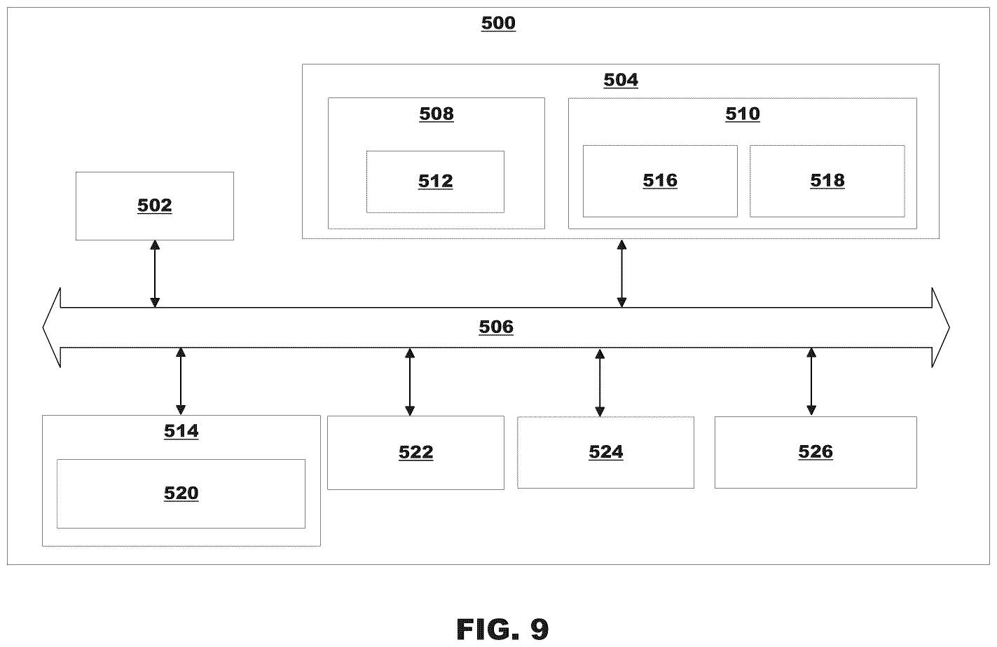

FIG. 9 is a schematic diagram of a computer system 500 for implementing examples disclosed herein. The computer system 500 is adapted to execute instructions from a computer-readable medium to perform these and/or any of the functions or processing described herein. The computer system 500 may be connected (e.g., networked) to other machines in a LAN, an intranet, an extranet, or the Internet. While only a single device is illustrated, the computer system 500 may include any collection of devices that individually or jointly execute a set (or multiple sets) of instructions to perform any one or more of the methodologies discussed herein. Accordingly, any reference in the disclosure and/or claims to a computer system, computing system, computer device, computing device, control system, control unit, electronic control unit (ECU), processor device, processing circuitry, etc., includes reference to one or more such devices to individually or jointly execute a set (or multiple sets) of instructions to perform any one or more of the methodologies discussed herein. For example, control system may include a single control unit or a plurality of control units connected or otherwise communicatively coupled to each other, such that any performed function may be distributed between the control units as desired. Further, such devices may communicate with each other or other devices by various system architectures, such as directly or via a Controller Area Network (CAN) bus, etc.

The computer system 500 may comprise at least one computing device or electronic device capable of including firmware, hardware, and/or executing software instructions to implement the functionality described herein. The computer system 500 may include processing circuitry 502 (e.g., processing circuitry including one or more processor devices or control units), a memory 504, and a system bus 506. The processing circuitry 502 may be the processing circuit 110 of the thermal runaway detection circuit 100, the processing circuit 310 of the battery pack 300 or configured to perform the features presented with reference to the processing circuit 110 of the thermal runaway detection circuit 100, the processing circuit 310 of the battery pack 300. The computer system 500 may include at least one computing device having the processing circuitry 502. The system bus 506 provides an interface for system components including, but not limited to, the memory 504 and the processing circuitry 502. The processing circuitry 502 may include any number of hardware components for conducting data or signal processing or for executing computer code stored in memory 504. The processing circuitry 502 may, for example, include a general-purpose processor, an application specific processor, a Digital Signal Processor (DSP), an Application Specific Integrated Circuit (ASIC), a Field Programmable Gate Array (FPGA), a circuit containing processing components, a group of distributed processing components, a group of distributed computers configured for processing, or other programmable logic device, discrete gate or transistor logic, discrete hardware components, or any combination thereof designed to perform the functions described herein. The processing circuitry 502 may further include computer executable code that controls operation of the programmable device.

The system bus 506 may be any of several types of bus structures that may further interconnect to a memory bus (with or without a memory controller), a peripheral bus, and/or a local bus using any of a variety of bus architectures. The memory 504 may be one or more devices for storing data and/or computer code for completing or facilitating methods described herein. The memory 504 may include database components, object code components, script components, or other types of information structure for supporting the various activities herein. Any distributed or local memory device may be utilized with the systems and methods of this description. The memory 504 may be communicably connected to the processing circuitry 502 (e.g., via a circuit or any other wired, wireless, or network connection) and may include computer code for executing one or more processes described herein. The memory 504 may include non-volatile memory 508 (e.g., read-only memory (ROM), erasable programmable read-only memory (EPROM), electrically erasable programmable read-only memory (EEPROM), etc.), and volatile memory 510 (e.g., random-access memory (RAM)), or any other medium which can be used to carry or store desired program code in the form of machine-executable instructions or data structures and which can be accessed by a computer or other machine with processing circuitry 502. A basic input/output system (BIOS) 512 may be stored in the non-volatile memory 508 and can include the basic routines that help to transfer information between elements within the computer system 500.

The computer system 500 may further include or be coupled to a non-transitory computer-readable storage medium such as the storage device 514, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 514 and other drives associated with computer-readable media and computer-usable media may provide non-volatile storage of data, data structures, computer-executable instructions, and the like.

Computer-code which is hard or soft coded may be provided in the form of one or more modules. The module(s) can be implemented as software and/or hard-coded in circuitry to implement the functionality described herein in whole or in part. The modules may be stored in the storage device 514 and/or in the volatile memory 510, which may include an operating system 516 and/or one or more program modules 518. All or a portion of the examples disclosed herein may be implemented as a computer program 520 stored on a transitory or non-transitory computer-usable or computer-readable storage medium (e.g., single medium or multiple media), such as the storage device 514, which includes complex programming instructions (e.g., complex computer-readable program code) to cause the processing circuitry 502 to carry out actions described herein. Thus, the computer-readable program code of the computer program 520 can comprise software instructions for implementing the functionality of the examples described herein when executed by the processing circuitry 502. In some examples, the storage device 514 may be a computer program product (e.g., readable storage medium) storing the computer program 520 thereon, where at least a portion of a computer program 520 may be loadable (e.g., into a processor) for implementing the functionality of the examples described herein when executed by the processing circuitry 502. The processing circuitry 502 may serve as a controller or control system for the computer system 500 that is to implement the functionality described herein.

The computer system 500 may include an input device interface 522 configured to receive input and selections to be communicated to the computer system 500 when executing instructions, such as from a keyboard, mouse, touch-sensitive surface, etc. Such input devices may be connected to the processing circuitry 502 through the input device interface 522 coupled to the system bus 506 but can be connected through other interfaces, such as a parallel port, an Institute of Electrical and Electronic Engineers (IEEE) 1394 serial port, a Universal Serial Bus (USB) port, an IR interface, and the like. The computer system 500 may include an output device interface 524 configured to forward output, such as to a display, a video display unit (e.g., a liquid crystal display (LCD) or a cathode ray tube (CRT)). The computer system 500 may include a communications interface 526 suitable for communicating with a network as appropriate or desired.

The operational actions described in any of the exemplary aspects herein are described to provide examples and discussion. The actions may be performed by hardware components, may be embodied in machine-executable instructions to cause a processor to perform the actions, or may be performed by a combination of hardware and software. Although a specific order of method actions may be shown or described, the order of the actions may differ. In addition, two or more actions may be performed concurrently or with partial concurrence.

Example 1. A thermal runaway detection circuit 100, comprising a processing circuit 110, a first electric conduit 121 configured to connect the processing circuit 110 to a first sensor circuit 201 and a second electric conduit 122 configured to connect the processing circuit 110 to a second sensor circuit 202, a portion 121′ of the first electric conduit 121 and a portion 122′ of the second electric conduit 122 between the processing circuit 110 and the respective sensor circuit 201, 202 are configured to be arranged at an over pressure relief path 205 of a battery device 200, wherein the processing circuit 110 is configured to: obtain first data 1100 via the first electric conduit 121 and second data 1200 via the second electric conduit 122, and generate a thermal runaway indication 101 based on the first data 1100 and the second data 1200.

Example 2. The thermal runaway detection circuit 100 of example 1, wherein the processing circuit 110 is configured to generate the thermal runaway indication 101 responsive to the first data 1100 being outside a first interval 1125 and the second data 1200 being outside a second interval 1225.

Example 3. The thermal runaway detection circuit 100 of any of examples 1-2, further comprising a first impedance control circuit 131 connected to the first electric conduit 121 between the processing circuit 110 and the over pressure relief path 205 and/or a second impedance control circuit 132 connected to the second electric conduit 122 between the processing circuit 110 and the over pressure relief path 205.

Example 4. The thermal runaway detection circuit 100 of example 3, wherein the processing circuit 110 is configured to generate the thermal runaway indication 101 responsive to the first data 1100 indicating a first data maximum value 1140 or a first data minimum value 1100 and/or the second data 1200 indicating a second data maximum value 1240 or a second data minimum value 1210.

Example 5. The thermal runaway detection circuit 100 of any of examples 1-4, wherein at least a portion of the first electric conduit 121 and a portion of the second electric conduit 122 are arranged on a printed circuit board, PCB, 120.

Example 6. The thermal runaway detection circuit 100 of example 5, wherein the PCB 120 is a flexible printed circuit, FPC.

Example 7. The thermal runaway detection circuit 100 of example 1, further comprising a first impedance control circuit 131 connected to the first electric conduit 121 between the processing circuit 110 and the over pressure relief path 205 and/or a second impedance control circuit 132 connected to the second electric conduit 122 between the processing circuit 110 and the over pressure relief path 205, wherein the processing circuit 110 is configured to generate the thermal runaway indication 101 responsive to the first data 1100 indicating a first data maximum value 1140 or a first data minimum value 1100 and the second data 1200 indicating a first data maximum value 1240 or a first data minimum value 1210; the processing circuit 110 is further configured to generate the thermal runaway indication 101 responsive to the first data 1100 being outside a first interval 1125 and the second data 1200 being outside a second interval 1225; at least a portion of the first electric conduit 121 and a portion of the second electric conduit 122 are arranged on a printed circuit board, PCB, 120, wherein the PCB 120 is a flexible printed circuit, FPC.

Example 8. A battery device 200 comprising at least one battery cell 210, a first sensor circuit 201, a second sensor circuit 202, a housing 220 enclosing the at least one battery cell 210 and comprising an over pressure relief path 205, and a thermal runaway detection circuit 100 of any one of the preceding examples connected to the first sensor circuit 201 and the second sensor circuit 202, wherein the first electric conduit 121 and the second electric conduit 122 of the thermal runaway detection circuit 100 are arranged at the pressure relief path 205.

Example 9. The battery device 200 of example 8, further comprising a pressure relief valve 223 arranged to control the over pressure relief path 205.

Example 10. The battery device 200 of example ay of examples 8-9, wherein the first sensor circuit 201 and/or the second sensor circuit 202 are one of a temperature sensor, a voltage sensor or a current sensor.

Example 11. A battery pack 300 comprising two or more battery devices 200 of any one of examples 8 to 10 and a battery pack processing circuit 310 connected to each of the processing circuits 110 of the two or more battery devices 200.

Example 12. The battery pack 300 of example 11, wherein the battery pack processing circuit 310 is configured to generate a battery pack thermal runaway indication 301 responsive to obtaining a thermal runaway indication 101 from at least one of the processing circuits 110 of the two or more battery devices 200.

Example 13. The battery pack 300 of example 12, wherein the battery pack processing circuit 310 is configured to generate the battery pack thermal runaway indication 301 responsive to obtaining thermal runaway indications 101 from at least two of the processing circuits 110 of the two or more battery devices 200.

Example 14. A vehicle 10 comprising at least one battery device 200 of any one of examples 8 to 10.

Example 15. The vehicle 10 of example 14, wherein the vehicle 10 is configured to alert an operator of the vehicle 10 responsive to the battery device 200 generating a thermal runaway indication 101.

Example 16. The vehicle 10 of any of examples 14-15, wherein the vehicle 10 is a heavy-duty vehicle.

Example 17. A vehicle 10 comprising at least one battery pack 300 of any one of examples 12 or 13.

Example 18. The vehicle 10 of example 17, wherein the vehicle 10 is configured to alert an operator of the vehicle 10 responsive to the battery pack 300 generating a battery pack thermal runaway indication 301.

Example 19. The vehicle 10 of any of examples 17-18, wherein the vehicle 10 is a heavy-duty vehicle.

Example 20. A method 400 of detecting thermal runaway of a battery device 200 according to any one of example 8 to 10, the method 400 comprising: obtaining 410 first data 1100 from the first electric conduit 121 and second data 1200 from the second electric conduit 122, and generating 420 a thermal runaway indication 101 based on the first data 1100 and the second data 1200.

Example 21. The method 400 of example 20, wherein generating 420 a thermal runaway indication 101 comprises generating the thermal runaway indication 101 responsive to the first data 1100 being outside a first interval 1125, and the second data 1200 being outside a second interval 1225.

Example 22. The method 400 of any of examples 20-21, wherein generating 420 a thermal runaway indication 101 comprises generating the thermal runaway indication 101 responsive to the first data 1100 indicating a first data maximum value 1140 or a first data minimum value 1100, and the second data 1200 indicating a second data maximum value 1240 or a second data minimum value 1210.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

1. A thermal runaway detection circuit, comprising a processing circuit, a first electric conduit configured to connect the processing circuit to a first sensor circuit and a second electric conduit configured to connect the processing circuit to a second sensor circuit, a portion of the first electric conduit and a portion of the second electric conduit between the processing circuit and the respective sensor circuit are configured to be arranged at an over pressure relief path of a battery device, wherein the processing circuit is configured to:
obtain first data via the first electric conduit and second data via the second electric conduit, and
generate a thermal runaway indication based on the first data and the second data.

2. The thermal runaway detection circuit of claim 1, wherein the processing circuit is configured to generate the thermal runaway indication responsive to the first data being outside a first interval and the second data being outside a second interval.

3. The thermal runaway detection circuit of claim 1, further comprising a first impedance control circuit connected to the first electric conduit between the processing circuit and the over pressure relief path and/or a second impedance control circuit connected to the second electric conduit between the processing circuit and the over pressure relief path.

4. The thermal runaway detection circuit of claim 3, wherein the processing circuit is configured to generate the thermal runaway indication responsive to the first data indicating a first data maximum value or a first data minimum value and/or the second data indicating a second data maximum value or a second data minimum value.

5. The thermal runaway detection circuit of claim 1, wherein at least a portion of the first electric conduit and a portion of the second electric conduit are arranged on a printed circuit board (“PCB”).

6. The thermal runaway detection circuit of claim 5, wherein the PCB is a flexible printed circuit (“FPC”).

7. The thermal runaway detection circuit of claim 1, further comprising a first impedance control circuit connected to the first electric conduit between the processing circuit and the over pressure relief path and/or a second impedance control circuit connected to the second electric conduit between the processing circuit and the over pressure relief path, wherein the processing circuit is configured to generate the thermal runaway indication responsive to the first data indicating a first data maximum value or a first data minimum value and the second data indicating a first data maximum value or a first data minimum value; the processing circuit is further configured to generate the thermal runaway indication responsive to the first data being outside a first interval and the second data being outside a second interval; at least a portion of the first electric conduit and a portion of the second electric conduit are arranged on a printed circuit board (“PCB”) wherein the PCB is a flexible printed circuit (“FPC”).

8. A battery device comprising at least one battery cell, a first sensor circuit, a second sensor circuit, a housing enclosing the at least one battery cell and comprising an over pressure relief path, and a thermal runaway detection circuit of claim 1 connected to the first sensor circuit and the second sensor circuit, wherein the first electric conduit and the second electric conduit of the thermal runaway detection circuit are arranged at the over pressure relief path.

9. The battery device of claim 8, further comprising a pressure relief valve arranged to control the over pressure relief path.

10. The battery device of claim 8, wherein the first sensor circuit and/or the second sensor circuit are one of a temperature sensor, a voltage sensor or a current sensor.

11. A battery pack comprising two or more battery devices of claim 8 and a battery pack processing circuit connected to each of the processing circuits of the two or more battery devices.

12. The battery pack of claim 11, wherein the battery pack processing circuit is configured to generate a battery pack thermal runaway indication responsive to obtaining a thermal runaway indication from at least one of the processing circuits of the two or more battery devices.

13. The battery pack of claim 12, wherein the battery pack processing circuit is configured to generate the battery pack thermal runaway indication responsive to obtaining thermal runaway indications from at least two of the processing circuits of the two or more battery devices.

14. A vehicle comprising at least one battery device of any claim 8.

15. The vehicle of claim 14, wherein the vehicle is configured to alert an operator of the vehicle responsive to the battery device generating a thermal runaway indication.

16. A vehicle comprising at least one battery pack of claim 11.

17. The vehicle of claim 16, wherein the vehicle is configured to alert an operator of the vehicle responsive to the battery pack generating a battery pack thermal runaway indication.

18. A method of detecting thermal runaway of a battery device according to claim 8, the method comprising:
obtaining first data from the first electric conduit and second data from the second electric conduit, and
generating a thermal runaway indication based on the first data and the second data.

19. The method of claim 18, wherein generating a thermal runaway indication comprises generating the thermal runaway indication responsive to the first data being outside a first interval, and the second data being outside a second interval.

20. The method of claim 19, wherein generating a thermal runaway indication comprises generating the thermal runaway indication responsive to the first data indicating a first data maximum value or a first data minimum value, and the second data indicating a second data maximum value or a second data minimum value.
